(19) United States
(12) Patent Application Publication
(10) Pub. No.: US 2016/0363732 A1
(43) Pub. Date: Dec. 15, 2016

(54) FIBER OPTIC CONNECTOR, FIBER OPTIC CONNECTOR AND CABLE ASSEMBLY, AND METHODS FOR MANUFACTURING

(71) Applicants: ADC Telecommunications, Inc., Berwyn, PA (US); Tyco Electronics Corporation, Berwyn, PA (US)

(72) Inventors: Steven C. Zimmel, Minneapolis, MN (US); Michael Andrew Oar, San Francisco, CA (US); Richard J. Drapeau, Victoria, MN (US); Dennis Marvin Braun, Waconia, MN (US); Michael James Ott, Chaska, MN (US)

(21) Appl. No.: 14/463,158

(22) Filed: Aug. 19, 2014

Related U.S. Application Data
(60) Provisional application No. 61/867,402, filed on Aug. 19, 2013.
(60) Provisional application No. 61/867,373, filed on Aug. 19, 2013.

(51) Int. Cl. G02B 6/38; B29D 11/00; G02B 6/255

(52) U.S. Cl. CPC G02B 6/3865; G02B 6/3846; G02B 6/3869; G02B 6/2551; B29D 11/0075; B29K 2063/00

(57) ABSTRACT

Some example methods of connectorizing an end of an optical cable include providing the ferrule assembly including a ferrule, a stub optical fiber extending rearwardly from the ferrule, and a flange disposed about the ferrule; splicing the stub optical fiber to an optical fiber of the optical cable at a splice location; and overmolding a rear hub portion (e.g., without any protective layers disposed between the rear hub portion and the stub optical fiber and optical fiber of the optical cable) using an adhesive material. The flange may include Nylon 6, 6. Splicing the fibers may include pulling the fibers away from each other during splicing without separating the fibers.

### CROSS-REFERENCE TO RELATED APPLICATIONS

The present application claims the benefit of U.S. Provisional Application No. 61/867,402, filed Aug. 19, 2013, and titled “Fiber Optic Connector, Fiber Optic Connector and Cable Assembly, and Methods for Manufacturing” and U.S. Provisional Application No. 61/867,373, filed Aug. 19, 2013, and titled “Fiber Optic Connector, Fiber Optic Connector and Cable Assembly, and Methods for Manufacturing,” the disclosures of which are hereby incorporated herein by reference in their entirety.

### TECHNICAL FIELD

The present disclosure relates generally to optical fiber communication systems. More particularly, the present disclosure relates to fiber optic connectors, fiber optic connector and cable assemblies and methods for manufacturing.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected and disconnected.

A typical fiber optic connector includes a ferrule assembly supported at a front end of a connector housing. The ferrule assembly includes a ferrule and a hub mounted to a rear end of the ferrule. A spring is used to bias the ferrule assembly in a forward direction relative to the connector housing. The ferrule functions to support an end portion of at least one optical fiber (in the case of a multi-fiber ferrule, the ends of multiple fibers are supported). The ferrule has a front end face at which a polished end of the optical fiber is located. When two fiber optic connectors are interconnected, the front end faces of their respective ferrules abut one another and the ferrules are forced together by the spring loads of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of a fiber optic adapter that receives the connectors, aligns the ferrules and mechanically holds the connectors in a connected orientation relative to one another.

A fiber optic connector is often secured to the end of a corresponding fiber optic cable by anchoring a tensile strength structure (e.g., strength members such as aramid yarns, fiberglass reinforced rods, etc.) of the cable to the connector housing of the connector. Anchoring is typically accomplished through the use of conventional techniques such as crimps or adhesive. Anchoring the tensile strength structure of the cable to the connector housing is advantageous because it allows tensile load applied to the cable to be transferred from the strength members of the cable directly to the connector housing. In this way, the tensile load is not transferred to the ferrule assembly of the fiber optic connector. If the tensile load were to be applied to the ferrule assembly, such tensile load could cause the ferrule assembly to be pulled in a proximal direction against the bias of the connector spring thereby possibly causing an optical disconnection between the connector and its corresponding mated connector. Fiber optic connectors of the type described above can be referred to as pull-proof connectors. In other connector styles, the tensile strength layer of the fiber optic cable can be anchored to the hub of the ferrule assembly.

Connectors are typically installed on fiber optic cables in the factory through a direct termination process. In a direct termination process, the connector is installed on the fiber optic cable by securing an end portion of an optical fiber of the fiber optic cable within a ferrule of the connector. After the end portion of the optical fiber has been secured within the ferrule, the end face of the ferrule and the end face of the optical fiber are polished and otherwise processed to provide an acceptable optical interface at the end of the optical fiber. A direct termination is preferred because it is fairly simple and does not have losses of the type associated with a spliced connection.

A number of factors are important with respect to the design of a fiber optic connector. One aspect relates to ease of manufacturing and assembly. Another aspect relates to connector size and compatibility with legacy equipment. Still another aspect relates to the ability to provide high signal quality connections with minimal signal degradation.

### SUMMARY

Aspects of the disclosure are directed to methods of connectorizing an end of an optical cable.

Some example methods include providing the ferrule assembly including a ferrule, a stub optical fiber extending rearwardly from the ferrule, and a flange disposed about the ferrule; splicing the stub optical fiber to an optical fiber of the optical cable at a splice location; and overmolding a rear hub portion using an adhesive material. The flange includes Nylon 6, 6 and the adhesive material forms a chemical bond with the Nylon 6, 6. The rear hub portion extends over the splice location and one end of the rear hub portion contacting at least a rearward surface of the flange.

Other example methods include providing a ferrule assembly including a ferrule, a stub optical fiber extending rearwardly from the ferrule, and a flange disposed about the ferrule; splicing the stub optical fiber to an optical fiber of the optical cable at a splice location; and overmolding a rear hub portion over the splice location without any protective layers disposed between the rear hub portion and the stub optical fiber and optical fiber of the optical cable. The rear hub portion cooperates with the flange to form a composite hub.

In certain examples methods, a shell is positioned at the flange and over the splice location; overmold material is injected into the shell so that the overmold material contacts the flange and the splice location; and the overmold material cures to form a composite hub with the shell and flange. In an example, the shell includes Nylon 6, 6.

Aspects of the disclosure include a method of splicing a first optical fiber to a second optical fiber. The method includes disposing the first and second optical fibers at respective first positions so that end faces of the first and second optical fibers are mostly aligned; initiating a fusion splice process on the first and second optical fibers; pulling the first and second optical fibers away from each other to respective second positions during before the fusion splice process completes; and completing the fusion splice process while the first and second optical fibers are disposed in the second positions. The first and second optical fibers are not pulled so far as to separate from each other.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a front, perspective, cross-sectional view of a ferrule assembly in accordance with the principles of the present disclosure;

FIG. 2 is a longitudinal cross-sectional view of the ferrule assembly of FIG. 1 with a dust cap installed on the ferrule;

FIG. 3 is a cross-sectional view taken along section line 3-3 of FIG. 2, the cross-sectional view shows a bare fiber portion of an optical fiber of the ferrule assembly;

FIG. 4 is a cross-sectional view taken along section line 4-4 of FIG. 2, the cross-section shows a coated fiber portion of the ferrule assembly;

FIG. 5 is a cross-sectional view showing an alternative configuration for the coated fiber portion of FIG. 4;

FIG. 6 is a perspective view of the ferrule assembly of FIG. 1;

FIG. 7 is a perspective view of a flange disposed about the ferrule assembly of FIG. 6;

FIG. 8 is a perspective view of the ferrule assembly of FIG. 6 spliced to an optical fiber cable;

FIG. 9 is a perspective view of a composite hub disposed about the splice of FIG. 8;

FIG. 10 is an exploded view of another example ferrule and hub assembly in accordance with the principles of the present disclosure;

FIG. 11 shows the ferrule and hub assembly of FIG. 10 in a partially assembled configuration;

FIG. 12 shows the optical fiber of the ferrule assembly of FIG. 1 in coarse alignment of the optical fiber of the fiber optic cable;

FIG. 13 shows the ferrule fiber precisely aligned with the fiber optic cable fiber, the aligned fibers are shown at an arc treatment station, arc shielding is also shown.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

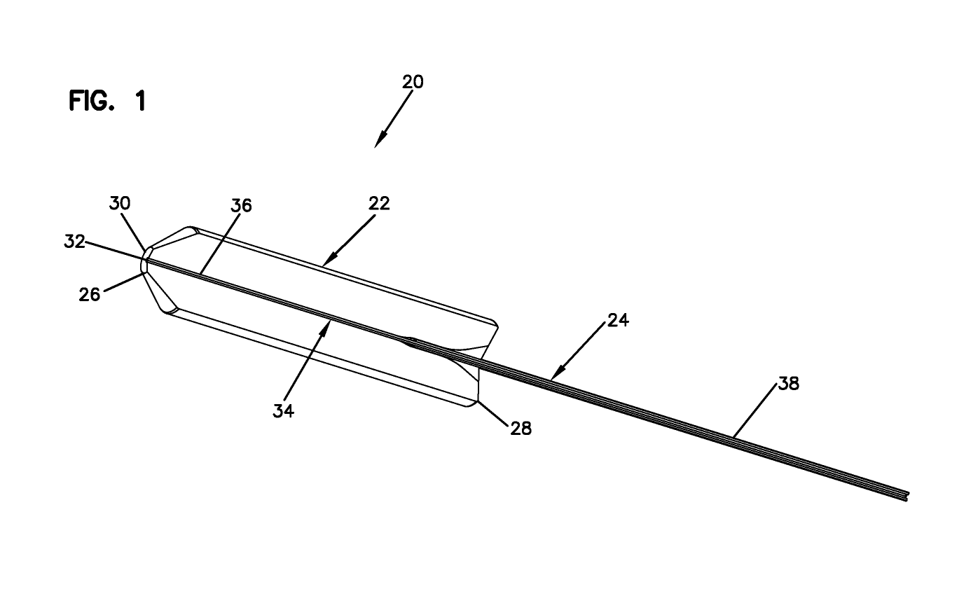

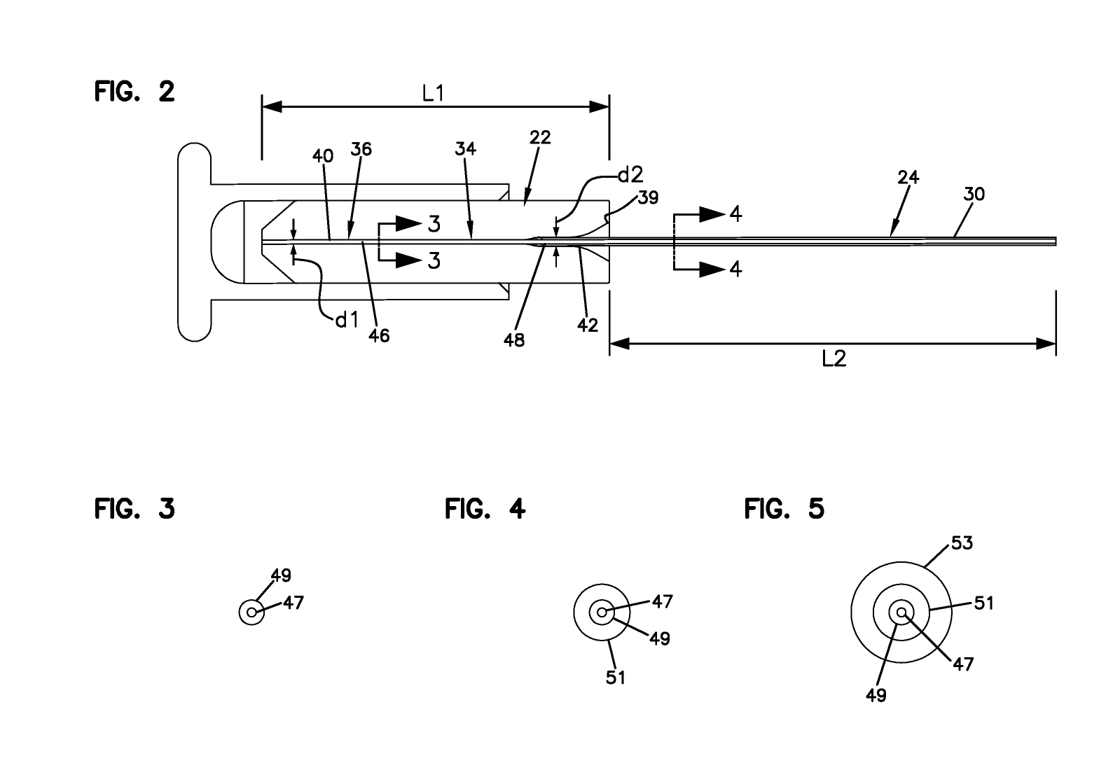

FIGS. 1-2 illustrate a ferrule assembly 20 in accordance with the principles of the present disclosure. The ferrule assembly 20 includes a ferrule 22 and an optical fiber stub 24 secured to the ferrule 22. The optical fiber stub 24 can be referred to as a “first optical fiber.” The ferrule assembly 20 is configured to be optical coupled (e.g., optically spliced) to an optical fiber cable to terminate the optical fiber cable. A fiber optic connector (e.g., an LC connection, an SC connector, an ST connection, an FC connection, an LX.5 connector, etc.) can be assembled or mounted to the ferrule assembly 20 to form a fiber optic cable and connector assembly.

The ferrule 22 includes a front end 26 positioned opposite from a rear end 28. The front end 26 preferably includes an end face 30 at which an interface end 32 of the optical fiber stub 24 is located. The ferrule 22 defines a ferrule bore 34 that extends through the ferrule 22 from the front end 26 to the rear end 28. The optical fiber stub 24 includes a first portion 36 secured within the ferrule bore 34 and a second portion 38 that extends rearwardly from the rear end 28 of the ferrule 22. The second portion 38 can be referred to as a “pigtail” or as a “free end portion.”

The ferrule 22 is preferably constructed of a relatively hard material capable of protecting and supporting the first portion 36 of the optical fiber stub 24. In one embodiment, the ferrule 22 has a ceramic construction. In other embodiments, the ferrule 22 can be made of alternative materials such as Ultem, thermoplastic materials such as Polyphenylene sulfide (PPS), other engineering plastics or various metals. In example embodiments, the ferrule 22 has a length L1 in the range of 5-15 millimeters (mm), or in the range of 8-12 mm.

The first portion 36 of the optical fiber stub 24 is preferably secured by an adhesive (e.g., epoxy) within the ferrule bore 34 of the ferrule 22. The interface end 32 preferably includes a polished end face accessible at the front end 32 of the ferrule 22.

As shown in FIG. 2, the ferrule bore 34 has a stepped-configuration with a first bore segment 40 having a first diameter d1 and a second bore segment 42 having a second diameter d2. The second diameter d2 is larger than the first diameter d1. A diameter step 44 provides a transition from the first diameter d1 to the second diameter d2. The first bore segment 40 extends from the front end 26 of the ferrule 22 to the diameter step 44. The second bore segment 42 extends from the diameter step 44 toward the rear end 28 of the ferrule 22. The ferrule bore 34 also includes a conical transition 39 that extends from the second bore segment 42 to the rear end 28 of the ferrule 22. In certain embodiments, the first diameter d1 is about 125.5 microns with a tolerance of +1 micron. In certain embodiments, the second diameter d2 can be about 250 microns so as to accommodate a coated optical fiber, or about 900 microns so as to accommodate a coated and buffered optical fiber. In one example, d1 is in the range of 230-260 microns and d2 is in the range of 500-1100 microns.

The first portion 36 of the optical fiber stub 24 includes a bare fiber segment 46 that fits within the first bore segment 40 of the ferrule 22 and a coated fiber segment 48 that fits within the second bore segment 42 of the ferrule 22. The bare fiber segment 46 is preferably bare glass and, as shown at FIG. 3, includes a core 47 surrounded by a cladding layer 49. In a preferred embodiment, the bare fiber segment 46 has an outer diameter that is no more than 0.4 microns smaller than the first diameter d1. In certain embodiments, the coated fiber segment 48 includes one or more coating layers 51 surrounding the cladding layer 49 (see FIG. 4). In certain embodiments, the coating layer or layers 51 can include a polymeric material such as acrylate having an outer diameter in the range of about 230-260 microns. In still other embodiments, the coating layer/layers 51 can be surrounded by a buffer layer 53 (e.g., a tight or loose buffer layer) (see FIG. 5) having an outer diameter in the range of about 500-1100 microns.

The second portion 38 of the optical fiber stub 24 preferably has a length L2 that is relatively short. For example, in one embodiment, the length L2 of the second portion 38 is less than the length L1 of the ferrule 22. In still other embodiments, the length L2 is no more than 20 mm, or is no more than 15 mm, or is no more than 10 mm. In still other embodiments, the length L2 of the second portion 38 is in the range of 1-20 mm, or in the range of 1-15 mm, or in the range of 1-10 mm, or in the range of 2-10 mm, or in the range of 1-5 mm, or in the range of 2-5 mm, or less than 5 mm, or less than 3 mm, or in the range of 1-3 mm.

An example process for manufacturing the ferrule assembly 20 of FIGS. 1-2 is disclosed in U.S. application Ser. No. 13/772,059 (hereinafter “the '059 application”), filed Feb. 20, 2013, and titled “Fiber Optic Connector, Fiber Optic Connector and Cable Assembly, and Methods For Manufacturing,” the disclosure of which is hereby incorporated herein by reference in its entirety. Aspects of the present disclosure are applicable to the various embodiments disclosed in the '059 application.

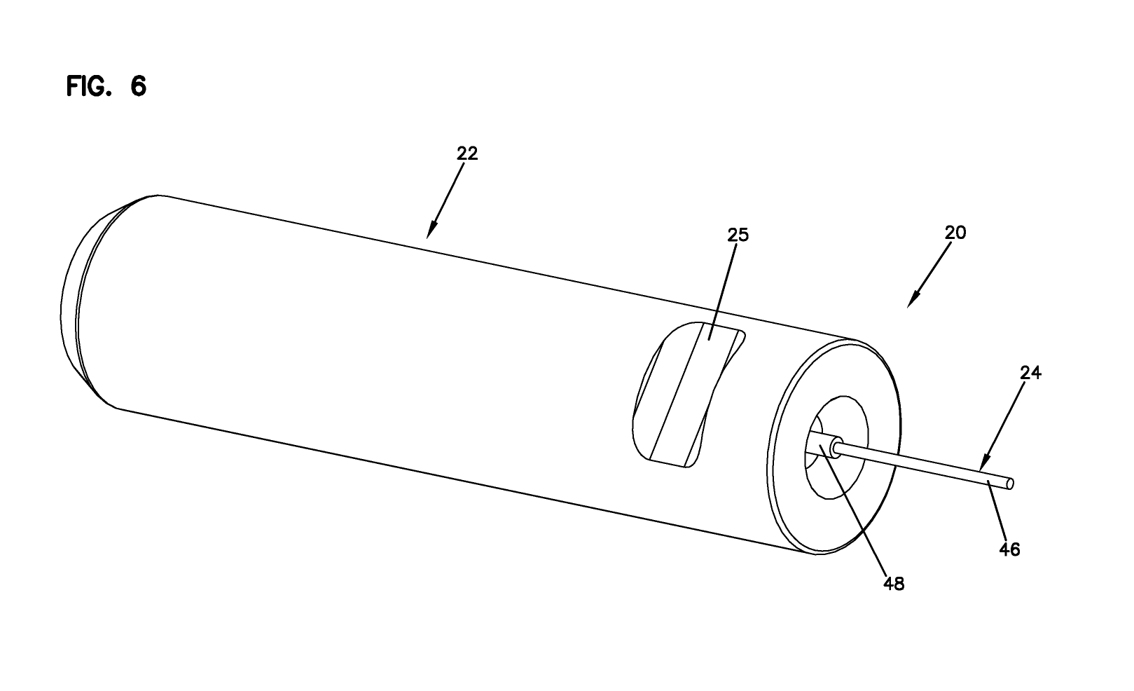

FIGS. 6-9 show a sequence for splicing an optical fiber stub 24 supported by a ferrule 22 to an optical fiber 216 of a fiber optic cable 217. As shown in FIG. 6, the optical fiber stub 24 includes a bare fiber segment 46 and a coated fiber segment 48. The ferrule 22 defines at least one notch 25 defined at the rear end 28 of the ferrule 22. In the example shown, the notch 25 is spaced inwardly from the rear end 28 of the ferrule 22. In the example shown, the notch 25 is cut into a side (e.g., an annular wall) of the ferrule 22.

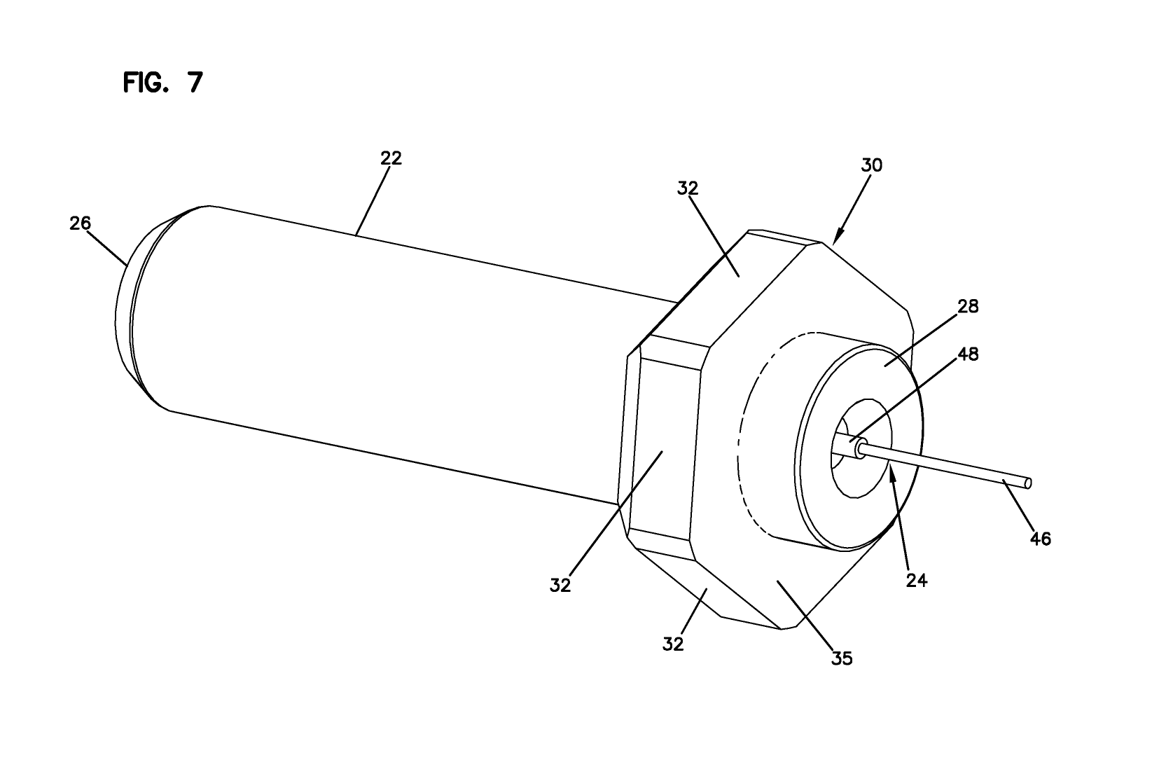

FIG. 7 shows a flange 30 disposed over a portion of the ferrule 22. The flange 30 extends over the notch 25 defined in the ferrule 22. The flange 30 can include a portion that extends into the notch 25 to enhance adhesion or retention to the ferrule 22 (e.g., by interlocking with the ferrule 22). The optical fiber stub 24 extends rearwardly of the flange 30. In some implementations, the rear 28 of the ferrule 22 extends rearwardly from the flange 30. In other implementations, the flange 30 covers the rear end 28 of the ferrule 22. In some implementations, the flange 30 defines flat sides 32 facing radially outwardly from the ferrule 22. In other implementations, a transverse cross-section of the flange 30 can be round or any other shape. The flange 30 defines a rearward surface 35 facing away from the front end 26 of the ferrule 22.

In certain embodiments, the flange 30 can be manufactured of a relatively hard plastic material such as a polyamide material. In some implementations, the flange 30 is pre-molded (e.g., overmolded) over the ferrule 22 prior to the optical fiber stub 24g being spliced to the optical fiber 216. During the pre-molding process, the material forming the flange 30 can enter the notch 25. In one embodiment, the flange 30 can be mounted (e.g., over molded) on the ferrule 22 prior to polishing, cleaning, cleaving, stripping, tuning, active alignment and splicing of the ferrule assembly. In this way, the flange 30 can be used to facilitate handling and positioning of the ferrule 22 during the various processing steps.

Marking can be placed on flat sides 32 of the flange 30 to aid in tuning. In certain embodiments, the flange 30 has six or eight flat sides 32. In one example, a flat side 32 of the flange 30 can be marked for tuning purposes. For example, the flat sides 32 closest to the core offset direction can be marked for later identification when the ferrule 22 assembly is loaded in a connector body. Thus, the marked flat side 32 can be used to identify (either manually or automatically) the core offset direction of the ferrule 22.

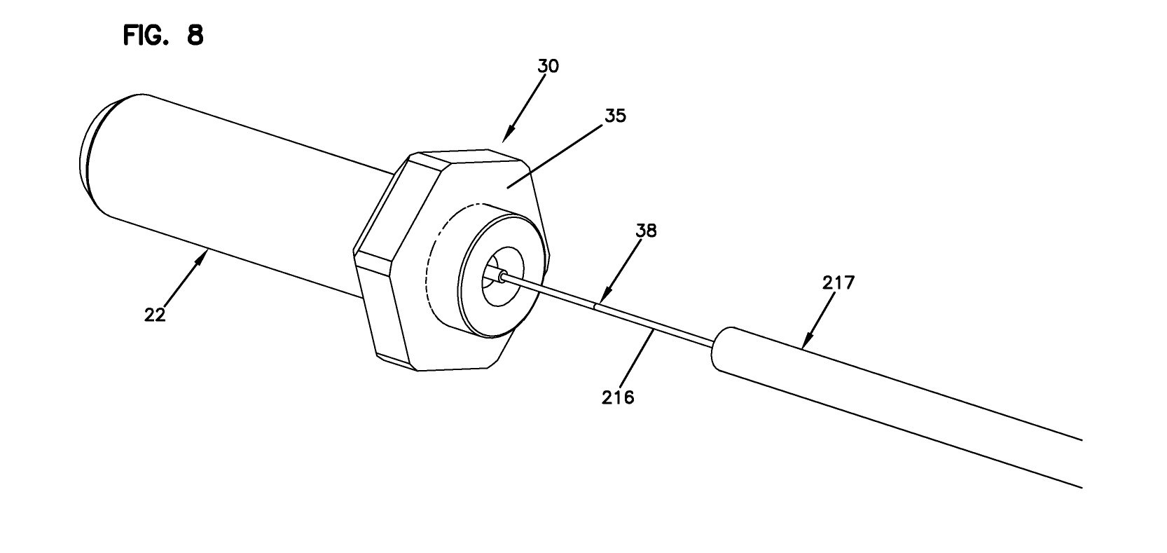

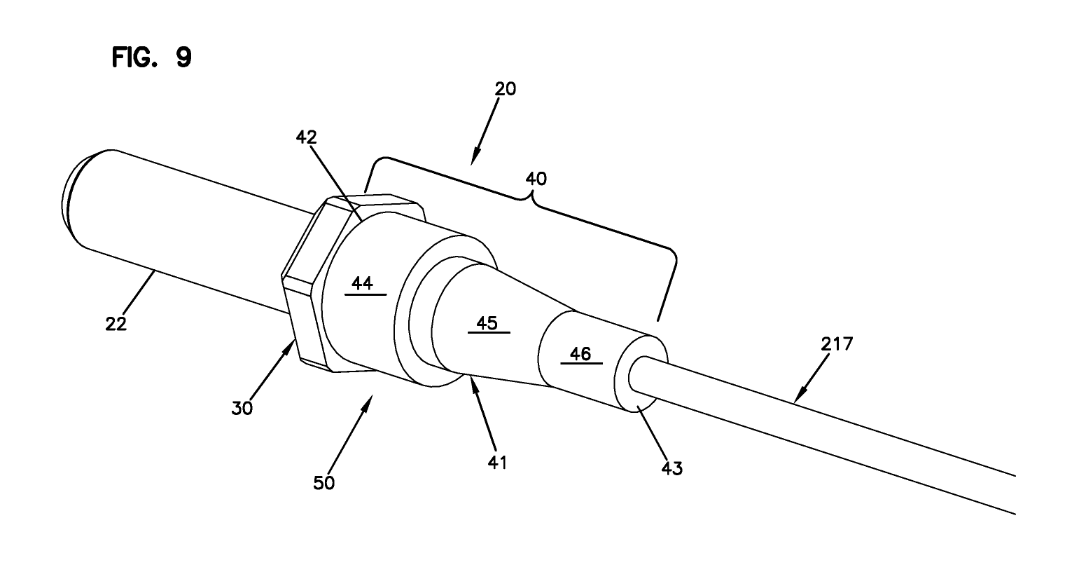

FIG. 8 shows the optical fiber stub 24 spliced to the optical fiber 216 at a splice location 38. In certain implementations, the optical fiber 216 includes a bare fiber segment and a coated portion. In certain implementations, the fiber optic cable 217 also includes a buffer tube that surrounds the coated portion of the optical fiber 216. In some implementations, the optical fiber stub 24 can be mechanically spliced to the optical fiber 216. In other implementations, the optical fiber stub 24 can be fusion spliced to the optical fiber 216.

To splice the optical fiber stub 24 to the optical fiber 216, the cable jacket of the fiber optic cable 217 is cut and slit, and the strength layer is trimmed. As so prepared, end portions of the optical fiber 216 extend outwardly from each end of the jacket. The end portions of the optical fiber 216 are then stripped, cleaned, and cleaved (e.g., laser cleaved). During stripping, cleaning, and cleaving, the end portions of the optical fiber 216 can be gripped in a holder (e.g., a holding clip or other structure).

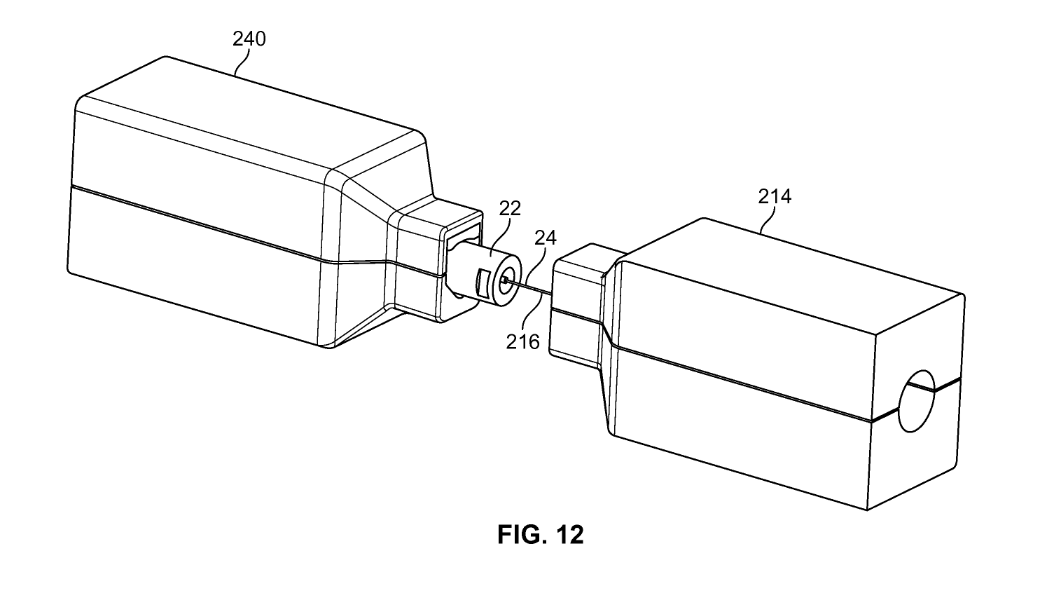

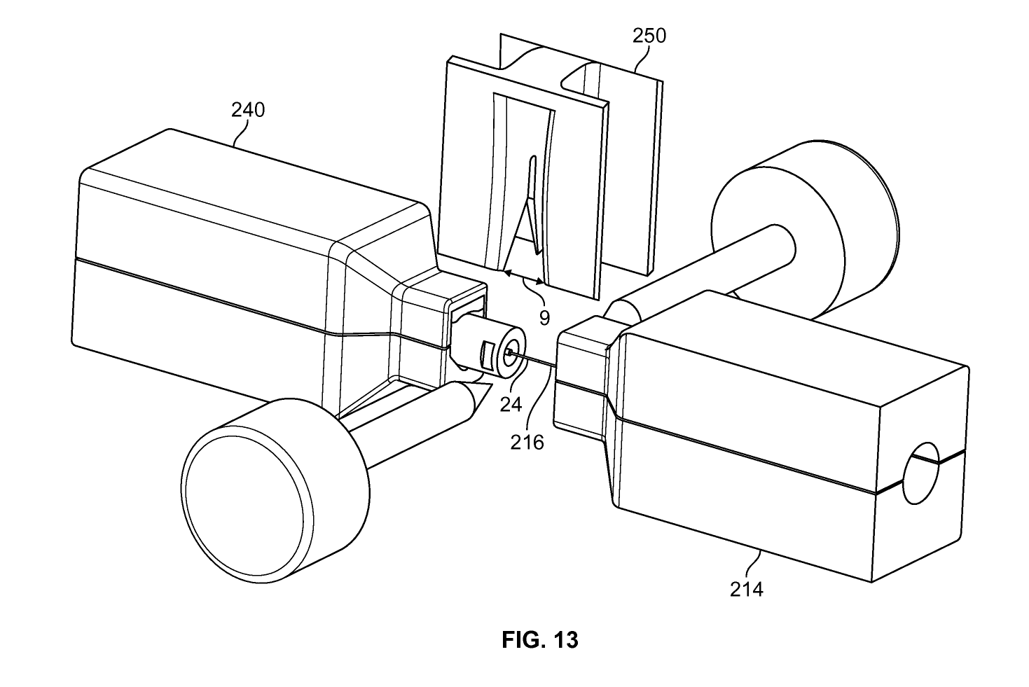

The ferrule assembly 20 can be fed (e.g., bowl fed) to a holder or holders which grip/hold the ferrule 22. While the ferrule 22 (or flange 30) is held by the holder, the free end of the optical fiber stub 24 is stripped, cleaned (e.g., arc cleaned), and cleaved (e.g., laser cleaved). Once the fibers have been stripped, cleaned, and cleaved, the optical fiber stub 24 of each ferrule assembly 20 is coarsely aligned with a corresponding end portion of optical fiber 216 (see FIG. 12), and then precisely aligned (see FIG. 13). Precise alignment of the optical fibers can be accomplished using an active alignment device. In using the active alignment device, the fiber 216 is held within the holders 214 with an end portion of the fiber 216 projecting outwardly from one end of the holder 214. Also, the ferrule 22 is held within a pocket of the holder 240 while the fiber 24 projects from the base of the ferrule 222 and is not contacted directly by the holder 240 or any other structure. The holder 240 can include a clip or other structure having two or more pieces that clamp and hold the ferrule 22 during active alignment of the fibers 216, 24. The pocket of the holder 240 can include an internal structure (e.g., a V-groove, semi-circular groove, etc. for aligning/positioning the ferrule 22). The end portions of the fibers are preferable unsupported (e.g., not in direct contact with a structure such as a v-groove). Robotics are preferably used to manipulate the holders 240, 214 to achieve axial alignment between the cores of the fibers 24, 216.

Precise alignment of the optical fibers can be accomplished using an active alignment device. In using the active alignment device, the fiber 216 is held within the holders with an end portion of the fiber 216 projecting outwardly from one end of the holder. Also, the ferrule 22 is held within a pocket of the holder while the fiber 24 projects from the base of the ferrule 222 and is not contacted directly by the holder or any other structure. The holder can include a clip or other structure having two or more pieces that clamp and hold the ferrule 22 during active alignment of the fibers 216, 24. The pocket of the holder can include an internal structure (e.g., a V-groove, semi-circular groove, etc. for aligning/positioning the ferrule 22). The end portions of the fibers are preferable unsupported (e.g., not in direct contact with a structure such as a v-groove). In one example, the fiber 24 projects less than 5 mm from the base end of the ferrule 22. This relatively short length facilitates the active alignment process. In certain examples, the center axis of the fiber 24 is angled no more than 0.1 degrees relative to the center line of the ferrule. This also assists the active alignment process. While ideally there is no angular offset between the center axis of the fiber 24 and the ferrule 22, the short stub length of the fiber 24 assist in minimizing the effect during active alignment of any angular offset that may exist. Robotics are preferably used to manipulate the holders to achieve axial alignment between the cores of the fibers 24, 216. Because alignment does not rely on contacting extended lengths of the fibers 24, 216 with alignment structure such as v-grooves, the splice location can be provided in close proximity to the base of the ferrule 22 (e.g., within 5 mm of the base). In certain embodiments, only splices in which the centers of the cores of the optical fibers 216, 24 being spliced are offset by no more than 0.01 microns are acceptable, and splices falling outside of this parameter are rejected. In other embodiments, the average core offset for fibers spliced by the process is less than 0.01 microns.

After precise axial alignment has been achieved, a shielding unit 250 is lowered over the splice location 218 and a fusion splice machine (e.g., an arc treatment machine) is used to fuse the optical fibers 24, 216 together. As noted above, in some implementations, while the cores of the stub optical fiber 24 and optical cable fiber 216 can be mostly aligned, the core of the stub optical fiber 24 may angle away from the core of the cable fiber 216. In such implementations, a fusion splice process can be initiated when the optical fibers (i.e., the optical stub fiber 24 and the optical fiber 216 of the cable 217) are disposed in respective first positions in which the optical fibers cores are mostly aligned, but angled relative to each other. Part of the way through the fusion splice process, the optical fibers are pulled away from each other to respective second positions. The fibers are pulled away a sufficient distance to improve alignment between the core of the optical stub fiber 24 and the core of the optical fiber 216 of the cable 217 while maintaining the fusion splice. However, the distance is not sufficient to separate the optical stub fiber 24 and the optical fiber 216 of the cable 217 from each other. The fusion splice process is completed while the fibers are disposed in the second positions.

After the fusion splice has been completed, a protective layer can be placed, applied or otherwise provided over the optical fibers 24, 216 in the region between the rear end 28 of the ferrule 22 and a buffered/coated portion of the optical fiber 216. In one example, the protective layer extends completely from the rear end 28 of the ferrule 22 to a coated and buffered portion of the optical fiber 216. As depicted, the coated and buffered portion of the optical fiber 216 includes coatings in the form of a 220-260 micron acrylate layers which cover the glass portion of the optical fiber, and a buffer layer (e.g., a loose or tight buffer tube) having an outer diameter ranging from 500-1,100 microns. In some implementations, the protective layer 232 extends over the splice location 38 completely from the rear end 28 of the ferrule 22 to the buffer layer of the optical fiber 216. In one embodiment, the protective layer is generally cylindrical and has a diameter slightly larger than the buffer layer and generally the same as a major diameter of the conical transition 39 of the ferrule bore 34. In other embodiments, the protective layer can have a truncated conical configuration with a major diameter generally equal to the outer diameter of the ferrule 22 and a minor diameter generally equal to the outer diameter of the buffer layer of the optical fiber 216. It will be appreciated that the protective layer can be applied using an over molding technique. Alternatively, coating, spraying, laminating or other techniques can be used to apply the protective layer.

Examples holders and protective layers suitable for use with the stub optical fibers 24 and cable fibers 216 discussed herein are disclosed in the '059 application incorporated by reference above.

After the flange 30 has been molded over the ferrule 22 and the fibers 24, 216 have been spliced together as shown at FIG. 8, a composite hub can be formed. FIGS. 9-11 illustrate examples of composite hubs. In the example shown in FIG. 9, the example composite hub 40 completely encapsulates the splice location 38. In some implementations, there is no protective layer between the hub 40 and the spliced optical fibers 46, 216. The hub 40 is overmolded directly over the spliced optical fibers 46, 216. It will be appreciated that the hub 40 can be used in any of the fiber optic connectors in accordance with the principles of the present disclosure.

In some implementations, the composite hub 40 is formed by molding (e.g., overmolding) a rear hub portion 41 over the splice location 38. In an example, the rear hub portion 41 is molded directly over the spliced optical fibers 46, 216 without any protective layer therebetween. The overmolded rear hub portion 41 extends from a first end 42 to a second end 43. The flange 30 is not covered by the rear hub portion 41. Rather, the first end 42 of the rear hub portion 41 contacts the rearward surface 35 of the flange 30. In this way, the flange 30 forms a front nose of the composite hub 40. The second end 43 of the rear hub portion 41 is disposed over the optical fiber cable 217 (e.g., over a jacketed portion of the cable 217).

In some implementations, the rear hub portion 41 includes a front portion 44 extending rearwardly from the first end 42 of the rear hub portion 41, a tapered portion 45 extending rearwardly from the front portion 44, and a rear portion 46 extending rearwardly from the tapered portion 45. The front portion 44 is sized to fit over the rear end 28 of the ferrule 22. The rear portion 46 is sized to fit over the optical fiber cable 217. The tapered portion 45 transitions the rear hub portion 41 between the front and rear portions 44, 46.

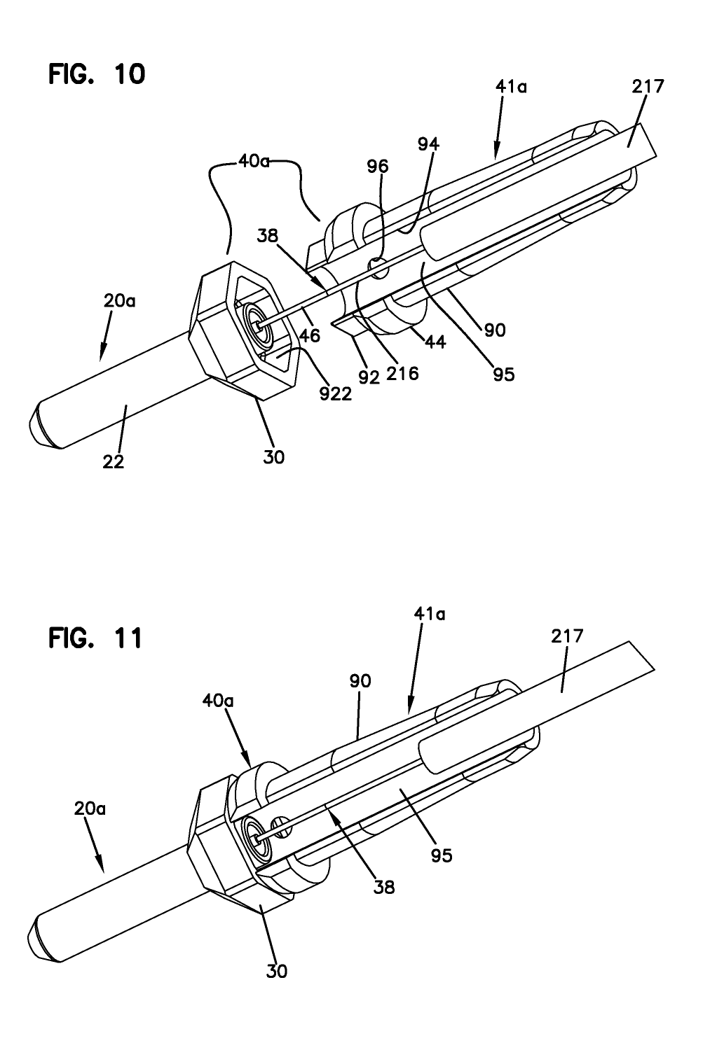

FIGS. 10 and 11 illustrate another example ferrule assembly 20a that includes an example composite hub 40a suitable for use to encapsulate the splice location 38. The composite hub 40a includes a front hub portion 30 and a rear hub portion 41a. The rear hub portion 41a includes an outer hub shell 90 defining an interior cavity 95. The outer hub shell 90 includes an axial/longitudinal slot 94 that allows the outer hub shell 90 to be inserted laterally over the optical fiber stub 46 and the optical fiber 216 at the splice location 38 after the optical fiber stub 46 has been spliced to the optical fiber 216. In an example, the outer hub shell 90 has a male end 92 that fits within a female receptacle 922 defined at a back side of a front hub portion 30. The male end 92 and the female receptacle 922 can have complementary shapes. As depicted, the male end 92 and the female receptacle 922 each include a series of flats that prevent relative rotation between the outer hub shell 90 and the front hub portion 30.

The outer hub shell 90 can function as a mold for shaping the over mold material around the splice location 38 and along the lengths of the optical fiber 216 and the optical fiber stub 46. The outer hub shell 90 also includes a port 96 for allowing the outer hub shell 90 to be filled with an over mold material (e.g., a UV curable material, a hot melt material, a thermoplastic material, an epoxy material, a thermoset material, or other materials). A temporary mold piece can be used to cover the axial slot 94 as the over mold material is injected into the outer hub shell 90 through the port 96. The outer hub shell 90 remains a permanent part of the hub 40a after the over mold material has been injected therein.

In certain embodiments, the rear hub portion 41, 41a is formed of a hot melt adhesive that can be applied and cured at relatively low molding temperatures and pressures. Rear hub portion 41, 41a can also be formed from a UV curable material (i.e., the materials cure when exposed to ultraviolet radiation/light), for example, UV curable acrylates, such as OPTOCAST™ 3761 manufactured by Electronic Materials, Inc. of Breckenridge, Colo.; ULTRA LIGHT-WELD® 3099 manufactured by Dymax Corporation of Torrington, Conn.; and 3M™ SCOTCH-WELD™ manufactured by 3M of St. Paul, Minn. The use of UV curable materials is advantageous in that curing can occur at room temperatures and at generally lower pressures (e.g. less than 30 kpsi, and generally between 20-30 kpsi). The availability of low pressure curing helps to ensure that the components, such as the optical fiber(s), being over molded are not damaged during the molding process.

In certain embodiments, the rear hub portion 41, 41a can be made of a thermoplastic material, a thermoset material (a material where cross-linking is established during heat curing), other types of cross-linked materials, or other materials. Example materials include acrylates, epoxies, urethanes, silicones and other materials. At least some of the materials can be UV curable (i.e., the materials cure when exposed to ultraviolet radiation/light). As described above, in certain embodiments, an injection molding process (e.g., a thermoplastic injection molding process) can be used to apply and form the rear hub portion 41 about the splice location 38 and ferrule 22. In certain embodiments, a hot melt material can be injected into the mold 90 to form the rear hub portion 41a. The use of hot melt materials (e.g., hot melt thermoplastic materials) and/or UV curable materials allows the hub over molding process to be conducted at relatively low pressures (e.g., less than 1000 pounds per square inch (psi)) and at relatively low temperatures (e.g., less than 300 degrees Celsius). In certain examples, curing can take place at temperatures less than 200 degrees Celsius, or less than 100 degrees Celsius, or at room temperature, and at pressures less than 100 psi or at pressures less than 10 or 5 psi.

In certain embodiments, the rear hub portion 41, 41a is made of a material having different material properties than the material of the flange 30. For example, the rear hub portion 41, 41a can be softer or more resilient than the flange 30. In other embodiments, the shell 90 of the rear hub portion 41a can be formed of the same material as the flange 30 and the injection material can be formed of a different material. The composite nature of the hub 40, 40a simplifies the molding operation. The flange 30 can be over molded using an over molding process having higher temperatures and pressures than the over molding process used to form the rear hub portion 41, 41a.

Chemical adhesion is a bonding mechanism whereby complimentary reactive groups from the two materials react and chemically bond to form an adhesive joint. Accordingly, adhesive strength between these two dissimilar materials is achieved through chemical adhesion. For example, the material forming the flange 30 can be chemically bonded to the material forming the rear hub portion 41, 41a. In some implementations, the material from which the flange 30 is formed includes a polymer material containing free amines as end groups. In certain implementations, the material forming the flange 30 includes a polyamide polymer containing free amines as end groups as well as amides along the polymer backbone. In certain examples, the material forming the flange 30 includes Nylon. In an example, the material forming the flange 30 includes Nylon 6, 6. In some implementations, the material from which the rear hub portion 41, 41a is formed includes an adhesive (e.g., an epoxy). Nylons bond well to epoxies due to the chemical bonding that takes place between the amine and epoxy groups within the two materials. The amines and amides act as nucleophiles which chemically react and bond to an epoxy functionality.

In some implementations, the material forming the rear hub portion 41, 41a (e.g., the injected material) includes an adhesive (e.g., thermoplastic material, a thermoset material, UV-curable material, etc.) and a filler that improves the robustness and durability of the rear hub portion 41, 41a. In certain examples, the filler is selected to reduce mismatches in the thermal coefficient of expansion between the material of the rear hub portion 41, 41a and the glass material of the fibers 46, 216 being spliced. In some examples, reducing the mismatch in thermal expansion between the materials enables the rear hub portion 41, 41a to be molded directly over the splice location 38 without any protective layers separating the rear hub portion 41, 41a from the optical fibers 46, 216. In certain implementations, the filler is formed as beads, spheres, particles, or other discrete structures to be mixed with the adhesive. Example materials for the filler include silica glass (i.e., silicon dioxide), carbonate, silica, silicon, glass, chopped fiberglass, or other materials. In certain implementations, the filler includes glass beads.

In some implementations, the material forming the rear hub portion 41, 41a includes at least about 25% filler by volume. In certain implementations, the material forming the rear hub portion 41, 41a includes at least about 30% filler by volume. In certain implementations, the material forming the rear hub portion 41, 41a includes about 30%-70% filler by volume. In some implementations, the material forming the rear hub portion 41, 41a includes at least about 25% filler by weight. In certain implementations, the material forming the rear hub portion 41, 41a includes at least about 30% filler by weight. In certain implementations, the material forming the rear hub portion 41, 41a includes about 30%-70% filler by weight.

In some embodiments, the composite construction of the composite hub 40, 40a relies on the flange 30 to provide mechanical strength and precision and for securement of the composite hub 40, 40a to the ferrule 22 (e.g., the flange 30 is bonded to the ferrule 22). In some embodiments, the composite construction of the composite hub 40, 40a relies on the rear hub portion 41, 41a for securement of the composite hub 40, 40a to the buffer tube and for providing additional protection with respect to the splice location 38 and the bare fiber segments 46, 216.

While various specific dimensions are provided above, it will be appreciated that the dimensions are applicable to some embodiments and that other embodiments within the scope of the present disclosure may use dimensions other than those specifically provided. Similarly, while various manufacturing tolerances are provided above, it will be appreciated that the manufacturing tolerances are applicable to some embodiments and that other embodiments within the scope of the present disclosure may use manufacturing tolerances other than those specifically provided. The above specification, examples and data provide a description of the inventive aspects of the disclosure. Many embodiments of the disclosure can be made without departing from the spirit and scope of the inventive aspects of the disclosure.

What is claimed is:

1. A method of connectorizing an end of an optical cable, the method comprising:
providing the ferrule assembly including a ferrule, a stub optical fiber extending rearwardly from the ferrule, and a flange disposed about the ferrule, the flange including Nylon 6, 6;
splicing the stub optical fiber to an optical fiber of the optical cable at a splice location; and
overmolding a rear hub portion using an adhesive material that forms a chemical bond with the Nylon 6, 6 of the flange, the rear hub portion extending over the splice location and one end of the rear hub portion contacting at least a rearward surface of the flange.

2. The method of claim 1, wherein the rear hub portion is overmolded over the splice location without any protective layer between the rear hub portion and the spliced optical fibers.

3. The method of claim 2, wherein the adhesive material includes a filler that reduces a thermal expansion of the adhesive material.

4. The method of claim 3, wherein the filler includes silica.

5. The method of claim 4, wherein the filler includes glass.

6. A method of connectorizing an end of an optical cable by splicing a stub optical fiber of a ferrule assembly to an optical fiber of the optical cable at a splice location, the method comprising:
providing the ferrule assembly including a ferrule, a stub optical fiber extending rearwardly from the ferrule, and a flange disposed about the ferrule;
splicing the stub optical fiber to an optical fiber of the optical cable at a splice location; and
overmolding a rear hub portion over the splice location without any protective layers disposed between the rear hub portion and the stub optical fiber and optical fiber of the optical cable, the rear hub portion cooperating with the flange to form a composite hub.

7. The method of claim 6, wherein the rear hub portion includes an adhesive material and a filler that reduces mismatches in thermal expansion between the stub optical fiber, the fiber of the optical cable, and the rear hub portion.

8. The method of claim 7, wherein the filler includes silica.

9. The method of claim 7, wherein the filler includes glass.

10. The method of claim 7, wherein the rear hub portion includes at least about 25% filler by volume.

11. The method of claim 7, wherein the rear hub portion includes about 30% filler by volume.

12. The method of claim 7, wherein the rear hub portion includes about 30%-70% filler by volume.

13. The method of claim 7, wherein the rear hub portion includes at least about 25% filler by weight.

14. The method of claim 7, wherein the rear hub portion includes at least about 30% filler by weight.

15. The method of claim 7, wherein the rear hub portion includes about 30%-70% filler by weight.

16. The method of claim 6, wherein the rear hub portion is overmolded so that one end of the rear hub portion contacts at least a rearward surface of the flange.

17. The method of claim 6, wherein overmolding a rear hub portion comprises:
positioning a shell at the flange and over the splice location;
injecting overmold material into the shell so that the overmold material contacts the flange and the splice location; and
allowing the overmold material to cure to form a composite hub with the shell and flange.

18. A method of splicing a first optical fiber to a second optical fiber, the method comprising:
disposing the first and second optical fibers at respective first positions so that end faces of the first and second optical fibers are mostly aligned;
initiating a fusion splice process on the first and second optical fibers;
pulling the first and second optical fibers away from each other to respective second positions during before the fusion splice process completes, wherein the first and second optical fibers are not pulled so far as to separate from each other; and
completing the fusion splice process while the first and second optical fibers are disposed in the second positions.

19. The method of claim 18, wherein the first and second optical fibers are angled relative to each other.

20. The method of claim 18, wherein the first optical fiber includes a stub optical fiber and wherein the second optical fiber is surrounded by a cable jacket.
